(19) United States
(12) Patent Application Publication
(10) Pub. No.: US 2024/0037293 A1
(43) Pub. Date: Feb. 1, 2024

(54) METHOD AND DEVICE FOR ANALYZING VIRTUAL POWER PLANT OPERATION RISK

(71) Applicants: North China Electric Power University, Beijing (CN); State Grid Jibei Electric Power Company Limited, Beijing (CN)

(72) Inventors: Dunnan LIU, Beijing (CN); Heping JIA, Beijing (CN); Yanbin LI, Beijing (CN); Xuanyuan WANG, Beijing (CN); Mingguang LIU, Beijing (CN); Genzhu LI, Beijing (CN); Xiaofeng XU, Beijing (CN); Zhen LIU, Beijing (CN); Bo NING, Beijing (CN)

(21) Appl. No.: 17/900,964

(22) Filed: Sep. 1, 2022

(30) Foreign Application Priority Data
Jul. 26, 2022 (CN) 2022108870093

(51) Int. Cl. G06F 30/20

(52) U.S. Cl. CPC G06F 30/20; G06F 2111/10

(57) ABSTRACT

Disclosed are a virtual power plant operation risk analysis method and a device. The method comprises: establishing a multi-state model of wind turbine output, analyzing influence of wind speed on wind turbine failure rate based on the multi-state model of wind turbine output, and establishing a wind turbine failure model considering wind turbine time-varying failure rate; establishing a multi-state model of wind turbine output considering the wind speed and the wind turbine time-varying failure rate by an improved general generating function method based on the multi-state model of wind turbine output and the wind turbine failure model considering the wind turbine time-varying failure rate; establishing a multi-state output model of virtual power plant based on the multi-state model of wind turbine output considering wind speed and wind turbine time-varying failure rate; and calculating operation risk indicators of virtual power plant through the multi-state output model of virtual power plant.

### CROSS-REFERENCE TO RELATED APPLICATIONS

This application claims priority to Chinese Patent Application No. 202210887009.3, filed on Jul. 26, 2022, the contents of which are hereby incorporated by reference.

### TECHNICAL FIELD

The application relates to the technical field of power system risk assessment, and in particular to a method and a device for analyzing virtual power plant operation risks.

### BACKGROUND

With the “carbon emission peak and carbon neutrality” goal put forward, distributed energy resources on a demand side of power, such as distributed wind power and industrial loads, can be aggregated into virtual power plant to improve the flexibility of power system. However, on the one hand, an output of the virtual power plant aggregated by distributed wind power is affected by uncertain factors such as wind speeds; on the other hand, different wind speeds have an impact on a failure rate of wind turbines, further affects the output of the virtual power plant composed of distributed power generators, and brings risks to the safe and reliable operation of the internal industrial loads of virtual power plants.

A conventional failure rate analysis model adopts fixed failure rate analysis, which is difficult to reflect influence of wind speeds and other factors on distributed generator equipment. In addition, the conventional reliability analysis model is generally a two-state model, and a multi-state model can be used to analyze a system reliability more accurately. Therefore, it is necessary to propose a method and a device for analyzing virtual power plant operation risk considering time-varying failure rates of distributed wind power.

### SUMMARY

The application aims to overcome the shortcomings of the prior art and provide a method and a device for analyzing virtual power plant operation risks. Compared with a conventional two-state reliability analysis method, a method for analyzing virtual power plant operation risk considering time-varying failure rate of distributed wind power is provided to analyze virtual power plant operation risks more accurately.

To achieve the above objective, the present application provides the following solutions.

A method for analyzing virtual power plant operation risk includes:

S1, establishing a multi-state model of wind turbine output,

S2, analyzing influence of wind speed on wind turbine failure rate based on the multi-state model of wind turbine output, and establishing a wind turbine failure model considering wind turbine time-varying failure rates;

S3, establishing a multi-state model of the wind turbine output considering the wind speed and the wind turbine time-varying failure rate by an improved general generating function method based on the multi-state model of wind turbine output and the wind turbine failure model considering wind turbine time-varying failure rate;

S4, establishing a multi-state output model of virtual power plant based on the multi-state model of the wind turbine output considering the wind speed and the wind turbine time-varying failure rate; and

S5, calculating operation risk indicators of the virtual power plant through the multi-state output model of virtual power plant, and completing an analysis of the virtual power plant operation risk.

Optionally, establishing the multi-state model of wind turbine output includes:
analyzing a relationship between wind speed and wind turbine output without considering wind turbine failure, building the multi-state model of wind turbine output based on the relationship between wind speed and wind turbine output, dividing wind speed S(t) into Kₛ states, modelling the wind turbine output with Markov process, and dividing wpᵢ¹(t) into Kₛ states, obtaining a time-varying probability value q_{i,k}(t) of the wind turbine output wp_{i,k}¹ of a kₛ-th state, and building the multi-state model of wind turbine output by using an improved general generating function method.

Optionally the relationship between wind speed and wind turbine output is:

$$w {p}_{i}^{1} ( t ) = \{ \begin{matrix}0 , 0 \leq s ( t ) \leq {s}_{i}^{c i} or s ( t ) > {s}_{i}^{c o} \\ {a}_{i} {s ( t )}^{3} + {b}_{i} , {s}_{i}^{ci} \leq s ( t ) \leq {s}_{i}^{c} \\ w {p}_{i}^{r} , {s}_{i}^{c} \leq s ( t ) \leq {s}_{i}^{c o}\end{matrix} ,$$

where t represents time, i represents a serial number of the wind turbines, wpᵢ¹(t) indicates output of a wind turbine i at the wind speed S(t) at time t, sᵢ^{ci}, sᵢ^{c}, sᵢ^{co}, represent cut-in wind speed, rated wind speed and cut-out wind speed of the wind turbine i, respectively, wpᵢ^{r} represents rated power of the wind turbine i; aᵢ and b₁ are correlation coefficients between the output of wind turbine and the wind speed, respectively,

$${a}_{i} = \frac{w {p}_{i}^{r}}{{( {s}_{i}^{c} )}^{3} - {( {s}_{i}^{c i} )}^{3}} , {b}_{i} = \frac{{( w {p}_{i}^{r} {s}_{i}^{c i} )}^{3}}{{( {s}_{i}^{c i} )}^{3} - {( {s}_{i}^{c} )}^{3}} .$$

The time-varying probability value q_{i,k}(t) of the wind turbine output wp_{i,k}¹ of the kₛ-th state is:

$$\{ \begin{matrix}\frac{{dq}_{i , k} ( t )}{dt} = [ {\sum }_{k = 1 , k \neq l}^{{K}_{s}} {q}_{i , l} ( t ) \times {γ}_{k , l}^{s} ] - {q}_{i , k} ( t ) {\sum }_{l = 1 , l \neq k}^{{K}_{s}} {γ}_{k , l}^{s} k = 1 , … , {K}_{s} \\ {q}_{i , k} ( {t}_{0} ) = 1 , {q}_{i , l} ( {t}_{0} ) = 0 , k \neq l\end{matrix} ,$$

where γ_{k,l}^{s} represents state transition rate of the wind turbine output from the kₛ-th state to the lₛ-th state, q_{i,k}(t₀) is a time-varying probability value of the wind turbine output in the kₛ-th state of the wind turbine i at time t₀, q_{i,l}(t₀) represents a time-varying probability value of the wind turbine output in the lₛ-th state of the wind turbine i at time t₀, and q_{i,l}(t) represents a time-varying probability value of the wind turbine output in a l-th state of the wind turbine i at a time t.

The multi-state model of the wind turbine output is:

$${u}_{i}^{1} ( z , t ) = {\sum }_{{k}_{s} = 1}^{{K}_{s}} {q}_{i , k} ( t ) \cdot {z}^{{wp}_{i , k}^{1}} ,$$

where uᵢ¹(z,t) represents improved general generating function representation method of output of wind turbine i regardless of wind turbine failure, Z represents a state value of random variable, and z^{wp}^{_{i,k}}^{¹} represents an output value of wind turbine i is wp_{i,k}¹.

Optionally, establishing the wind turbine failure model considering wind turbine time-varying failure rate includes:
analyzing influence of wind speed on wind turbine failure rates, and establishing a wind turbine failure model;

λ_{I}(t)=λ_{i,0}+λ_{i,s}(t),
where λᵢ(t) represents wind turbine time-varying failure rate i at time t, λ_{i,0} represents basic failure rate of wind turbine i, and λ_{i,s}(t) represents variable failure rate of wind turbine i caused by wind speed at time t.

A relationship model between the variable failure rate of wind turbine i caused by wind speed at time t and wind speed s(t) is as follows:

λ_{i,s}(t)=(λ_{i,max}s(t)²−λ_{i,min}s(t)²)/(sᵢ^{co2}−sᵢ^{ci2})+cₛ,
where λ_{i,max} represents wind turbine failure rate corresponding to the cut-out wind speed sᵢ^{co} of the wind turbine i, λ_{i,min} represents wind turbine failure rate corresponding to the cut-in wind speed Sᵢ^{ci} of the wind turbine i, and Cₛ represents constants related to the cut-in wind speed and the cut-out wind speed.

Optionally, the basic failure rate of the wind turbine at different wind speeds is described by the multi-state model, and the variable failure rate of the wind turbine at different wind speeds is considered, so that failure probability of the wind turbine is:

q_{i,k}^{wt}(t)=1−e^{-λ}^{_{i,k}}^{t}.

In above formula, t is time, q_{i,k}^{wt} represents the failure probability of wind turbine i at kₛ-th wind speed at time t , and the failure rate of wind turbine i at the kₛ-th wind speed at time t.

Based on the failure probability of the wind turbine, the failure model of the wind turbine i in the kₛ-th wind speed state is established by using the improved general generating function method:

uᵢ²(z,t)=(1−q_{i,k}^{wt}(t)·z¹+q_{i,k}^{wt}(t)·z⁰=e^{-λ}^{_{i,k}}^{t}·z¹+(1−e^{-λ}^{_{i,k}}^{t})·z⁰,
where uᵢ²(z,t) represents the improved general generating function representation method of failure model of wind turbine i considering the influence of wind speed on wind turbine failure probability, z¹ indicates that wind turbine i is in normal operation and z⁰ indicates wind turbine i is in failure.

Optionally, the multi-state model of the wind turbine output considering the wind speed and the wind turbine time-varying failure rate is:

$$\begin{matrix}{u}_{i}^{w} ( z , t ) = {Ω}_{s e r} \{ {u}_{i}^{1} ( z , t ) , {u}_{i}^{2} ( z , t ) \} \\ = {Ω}_{s e r} \{ {\sum }_{{k}_{s} = 1}^{{K}_{s}} {q}_{i , k} ( t ) \cdot {z}^{w {p}_{i , k}^{1}} , ( 1 - {q}_{i , k}^{w t} ( t ) ) \cdot {z}^{1} + {q}_{i , k}^{w t} ( t ) \cdot {z}^{0} \} \\ = {Ω}_{s e r} \{ {\sum }_{{k}_{s} = 1}^{{K}_{s}} {q}_{i , k} ( t ) \cdot {z}^{w {p}_{i , k}^{1}} , {e}^{- {λ}_{i , k} t} \cdot {z}^{1} + ( 1 - {e}^{- {λ}_{i , k} t} ) \cdot {z}^{0} \} \\ = {{\sum }_{{k}_{s} = 1}}^{{K}_{s}} {q}_{i , k} ( t ) \cdot ( 1 - {q}_{i , k}^{w t} ( t ) ) \cdot {z}^{w {p}_{i , k}^{1}} + {{\sum }^{{K}_{s}}}_{{k}_{s} = 1} {q}_{i , k} ( t ) \cdot {q}_{i , k}^{w t} ( t ) \cdot {z}^{0} \\ = {{\sum }_{j = 1}}^{{n}_{w}} {q}_{i , j}^{w} ( t ) \cdot {z}^{w {p}_{i , j}^{w}}\end{matrix} ,$$

where uᵢ^{w}(z,t) represents the improved general generating function representation method of wind turbine i output model considering wind speed and wind turbine time-varying failure rate, Ωₛₑᵣ represents a series operator, q_{i,j}^{w}(t) represents a probability of wind turbine i in state j, and z^{wp}^{_{i,j}}^{^{w}} represents the output value of wind turbine i in state j.

Optionally, the multi-state model of the virtual power plant composed of a plurality of distributed wind power is established through the multi-state model of wind turbine output considering wind speed and the wind turbine time-varying failure rate:

$${u}^{V P P} ( z , t ) = {Ω}_{p a r} \{ {u}_{1}^{w} ( z , t ) , … , {u}_{i}^{w} ( z , t ) , … , {u}_{{N}_{w}}^{w} ( z , t ) \} = {\sum }_{i = 1}^{{N}_{w}} {\sum }_{j = 1}^{{n}_{w}} {q}_{i , j}^{w} ( t ) \cdot {z}^{w {p}_{i , j}^{w}}$$

$$= {\sum }_{m = 1}^{{N}_{v p p}} {q}_{m}^{v p p} ( t ) \cdot {z}^{V P {P}_{m}} ,$$

where u^{VPP}(z,t) represents an improved general generating function representation method for the output model of virtual power plant by aggregating N_{w} independent wind turbines, and Ωₚₐᵣ represents parallel operator, qₘ^{vpp}(t) represents a probability of virtual power plant in state m, and z^{VPP}^{ₘ} represents that the output value of virtual power plant in state m is VPPₘ.

Optionally, operation risk indicators of the virtual power plant are calculated:

$$D ( t ) = {\sum }_{m} {q}_{m}^{vpp} ( t ) , {VPP}_{m} \geq L ,$$

$$E ( t ) = {\sum }_{w} {q}_{m}^{vpp} ( t ) \cdot {VPP}_{m} ,$$

$$A ( T ) = {\sum }_{t = 0}^{T} ( L - {VPP}_{m} ) {q}_{m}^{vpp} ( t ) cdf ( τ ) , {VPP}_{m} < L ,$$

where D(t) is a power supply shortage probability, E(t) is expected power supply shortage and A(t) is power supply shortage loss for industrial users, L represents load value of industrial users powered by the virtual power plant, T represents total power supply time of the virtual power plant, and t represents the time and t ∈[0,T], τ indicates duration of power outage, cdf (τ) indicates loss function of power supply shortage of industrial users, and is related to the duration τ of power outage.

In order to achieve the above objectives, the present application also provides a device for analyzing virtual power plant operation risks, and the device includes:
a wind speed and wind turbine output module, used to construct the relationship model between wind turbine output and wind speed, divide wind speed into multiple states, and establish a multi-state wind speed model; calculate the wind turbine output value and the corresponding probability value without considering the wind turbine failure according to the relationship model between wind turbine output and wind speed and the multi-state output model of the wind turbine,
a wind turbine time-varying failure rate acquisition module for acquiring the variable failure rate of the wind turbines, and obtaining the wind turbine time-varying failure rate by adding the basic failure rate of the wind turbine and the variable failure rate of the wind turbine caused by the wind speed,
a wind turbine output module considering wind speed and wind turbine time-varying failure rate for constructing the wind turbine failure model considering wind turbine time-varying failure rate based on the wind turbine time-varying failure rate acquisition module; obtaining the wind turbine output value and the corresponding probability value considering the wind speed and the wind turbine time-varying failure rate based on the wind turbine output obtained by the wind speed and wind turbine output module, and
a virtual power plant operation risk assessment module for constructing a virtual power plant output model including a plurality of distributed wind powers; establishing a virtual power plant operation risk indicator system including power supply shortage probability, expected power supply shortage and power supply shortage loss of industrial users in virtual power plant, and calculating the power supply shortage probability, expected power supply shortage and power supply shortage loss of industrial users in virtual power plant.

The application has following beneficial effects.

The method and the device for analyzing virtual power plant operation risks provided by the application calculate the power supply shortage probability, expected power supply shortage, power supply shortage loss of industrial users in the virtual power plant, etc. for quantitatively evaluating the operation risk indicators of virtual power plant by analyzing the influence of wind speed on wind turbine failure rate, considering the influence of wind turbine time-varying failure rate on distributed wind power output, and considering multi-state characteristics of virtual power plant output in an actual operation process, so as to improve the operation risk assessment accuracy and reliability of the virtual power plant composed of distributed wind powers.

### BRIEF DESCRIPTION OF THE DRAWINGS

In order to more clearly explain the embodiments of the present application or the technical solutions in the prior art, the following will briefly introduce the drawings that need to be used in the embodiments. Obviously, the drawings in the following description are only some embodiments of the present application. For those of ordinary skill in the art, other drawings may be obtained according to these drawings without any creative labor.

FIG. 1 is a flow chart of a method for analyzing virtual power plant operation considering time-varying failure of distributed wind power provided by an embodiment of the present application.

FIG. 2 is a schematic diagram of a virtual power plant structure model in the virtual power plant operation analysis method considering the time-varying failure rate of distributed wind power provided by an embodiment of the present application.

FIG. 3 is a probability result diagram of power supply shortage of virtual power plant in an embodiment of the present application, whether time-varying failure rate of distributed wind power is considered or not.

FIG. 4 is a structural schematic diagram of a virtual power plant operation risk analysis device considering time-varying failure rate of distributed wind power provided by an embodiment of the present application.

### DETAILED DESCRIPTION OF THE EMBODIMENTS

The technical solutions in embodiments of the present application will be clearly and completely described below with reference to the drawings in embodiments of the present application. Obviously, the described embodiments are only part of the embodiments of the present application, but not all of them. Based on the embodiment of the present application, all other embodiments obtained by ordinary technicians in the field without creative labor are within the scope of the present application.

In order to make the above objects, features and advantages of the present application more obvious and understandable, the present application will be explained in further detail below with reference to the drawings and detailed description.

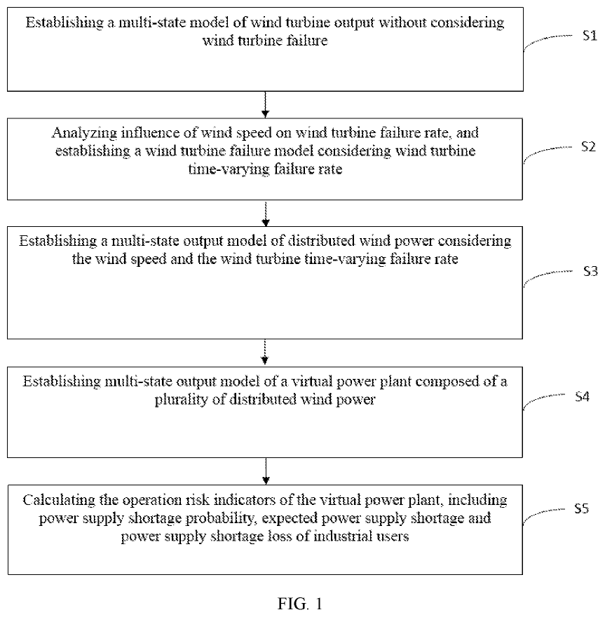

A flow chart of a virtual power plant operation risk analysis method shown in FIG. 1 specifically includes:

S1, A multi-state model of wind turbine output without considering wind turbine failure is established.

The S1 specifically includes:
(1) relationship between wind speed and wind turbine output is analyzed without considering wind turbine failure.

When the wind turbine is running well, relationship between output of wind turbine i and the wind speed is expressed by the following formula:

$$w {p}_{i}^{1} ( t ) = \{ \begin{matrix}0 , 0 \leq s ( t ) \leq {s}_{i}^{ci} or s ( t ) > {s}_{i}^{co} \\ {a}_{i} {s ( t )}^{3} + {b}_{i} , {s}_{i}^{ci} \leq s ( t ) \leq {s}_{i}^{c} \\ {wp}_{i}^{r} , {s}_{i}^{c} \leq s ( t ) \leq {s}_{i}^{co}\end{matrix} ,$$

where t represents time, i represents a serial number of the wind turbines, wpᵢ¹(t) indicates output of the wind turbine i at the wind speed S(t) at time t, sᵢ^{ci}, sᵢ^{c}, sᵢ^{co} represent cut-in wind speed, rated wind speed and cut-out wind speed of the wind turbine i, respectively, wpᵢ^{r} represents rated power of the wind turbine i; aᵢ and bᵢ are correlation coefficients between the output of the wind turbine and the wind speed, respectively,

$${a}_{i} = \frac{{wp}_{i}^{r}}{{( {s}_{i}^{c} )}^{3} - {( {s}_{i}^{c i} )}^{3}} ,$$

$${b}_{i} = \frac{{( {wp}_{i}^{r} {s}_{i}^{ci} )}^{3}}{{( {s}_{i}^{ci} )}^{3} - {( {s}_{i}^{c} )}^{3}} .$$

(2) The multi-state model of wind turbine output is established without considering wind turbine failure.

The wind speed S(t) is divided into Kₛ states, and a multi-state wind speed model is established. The wind speed of kₛ(kₛ=1, . . . ,Kₛ)-th state is sₖ, and sₖ<sₖ₊₁. Transition rate between different wind speed states kₛ, lₛ is γ_{k,l}^{s} where kₛ and lₛ represent serial numbers of different wind speed states, respectively.

The multi-state model of wind turbine output is established according to the relationship between wind turbine output and wind speed in normal operation of wind turbine. Markov process is used to model the wind turbine output, wpᵢ¹(t) is divided into Kₛ states, and the wind turbine output in the kₛ(kₛ=1, . . . , Kₛ)-th state is wp_{i,k}¹, and wp_{i,k}¹<wp_{i,k+1}¹. Time-varying probability value q_{i,k}(t) of the wind turbine output wp_{i,k}¹ in the kₛ-th state is obtained according to differential equations of multi-state Markov process as follows:

$$\{ \begin{matrix}\frac{{dq}_{i , k} ( t )}{dt} = [ {\sum }_{k = 1 , k \neq l}^{{K}_{s}} {q}_{i , l} ( t ) \times {γ}_{k , l}^{s} ] - {q}_{i , k} ( t ) {\sum }_{l = 1 , l \neq k}^{{K}_{s}} k = 1 , … , {K}_{s} \\ {q}_{i , k} ( {t}_{0} ) = 1 , {q}_{i , l} ( {t}_{0} ) = 0 , k \neq l\end{matrix} .$$

A multi-state model of the output of the wind turbine i is established by using an improved general generating function method and is expressed by following formula.

$${u}_{l}^{1} ( z , t ) = {\sum }_{{k}_{s} = 1}^{{K}_{s}} {q}_{i , k} ( t ) \cdot {z}^{{wp}_{i , k}^{1}} ,$$

where uᵢ¹(z,t) represents improved general generating function representation method of the output of the wind turbine i regardless of wind turbine failure, Z represents a state value of random variable, and z^{wp}^{_{i,k}}^{¹} represents an output value of wind turbine i is wp_{i,k}¹.

S2, Influence of wind speed on wind turbine failure rate is analyzed, and a wind turbine failure model is established considering the wind turbine time-varying failure rate.

The S2 specifically includes:
(1) the influence of wind speed on wind turbine failure rate is analyzed, and a wind turbine time-varying failure model is established.

As the wind turbine failure in the virtual power plant is closely related to the wind speed, the application considers the influence of the wind speed change on the wind turbine failure rate, and the wind turbine time-varying failure rate consists of basic failure rate of the wind turbine and variable failure rate of the wind turbine caused by the wind speed, as shown in the following formula:

λ_{I}(t)=λ_{i,0}+λ_{i,s}(t),
where λ_{I} (t) represents the wind turbine time-varying failure rate i at time t, λ_{i,0} represents basic failure rate of wind turbine i, and λ_{i,s}(t) represents variable failure rate of wind turbine i caused by wind speed at time t.

A relationship model between the variable failure rate of wind turbine i caused by wind speed at time t and wind speed s(t) is as follows:

λ_{i,s}(t)=(λ_{i,max}s(t)²−λ_{i,min}s(t)²)/(sᵢ^{co2}−sᵢ^{ci2})+cₛ,
where λ_{i,max} represents a wind turbine failure rate corresponding to the cut-out wind speed sᵢ^{co} of the wind turbine i, λ_{i,min} represents a wind turbine failure rate corresponding to the cut-in wind speed Sᵢ^{ci} of the wind turbine i, and cₛ represents constants related to the cut-in wind speed and the cut-out wind speed. It can be seen from the above formula that the greater the wind speed, the greater the wind turbine failure rate.
(2) a wind turbine failure model considering the wind turbine time-varying failure rate is established.

According to the application, the influence of the change of wind speed on the failure rate of the wind turbine is considered, and a multi-state model is adopted to describe the failure rate of the wind turbine at different wind speeds. Accordingly, the failure rate λᵢ (t) of the wind turbine i is divided into Kₛ states according to divided s(t) states of wind speed s(t), and the failure rate of the kₛ(kₛ=1, . . . , Kₛ)-th state is λ_{i,k} and λ_{i,k}<λ_{i,k+1}. The failure model of the wind turbine usually adopts two-state model. The two-state refers to normal operation state and complete failure state. Considering the wind turbine time-varying failure rate λ_{i,k} under different wind speeds, the failure probability of the wind turbine under the kₛ(kₛ=1, . . . , Kₛ)-th wind speed state is obtained as follows:

q_{i,k}^{wt}(t)=1−e^{-λ}^{_{i,k}}^{t},
where q_{i,k}^{wt}(t) represents the failure probability of wind turbine i at kₛ-th wind speed at time t.

Based on the failure probability of the wind turbine, the failure model of the wind turbine i in the kₛ-th wind speed state is established by using the improved general generating function method:

uᵢ²(z,t)=(1−q_{i,k}^{wt}(t)·z¹+q_{i,k}^{wt}(t)·z⁰=e^{-λ}^{_{i,k}}^{t}·z¹+(1−e^{-λ}^{_{i,k}}^{t})·z⁰,
where uᵢ²(z,t) represents the improved general generating function representation method of failure model of wind turbine i considering the influence of wind speed on wind turbine failure probability, z¹ indicates that wind turbine i is in normal operation and z⁰ indicates wind turbine i is in failure.

S3, On the basis of S1 and S2, a multi-state output model of distributed wind power considering wind speed and wind turbine time-varying failure rate is established.

The S3 specifically includes:
based on the multi-state model of wind turbine output without considering wind turbine failure in Si and the wind turbine failure model considering wind turbine time-varying failure rate in S2, a multi-state model of output of the wind turbine i considering wind speed and wind turbine time-varying failure rate is established by using the improved general generating function method and is expressed by the following formula:

$$\begin{matrix}{u}_{i}^{w} ( z , t ) = {Ω}_{ser} \{ {u}_{i}^{1} ( z , t ) , {u}_{i}^{2} ( z , t ) \} \\ = {Ω}_{ser} \{ {\sum }_{{k}_{s} = 1}^{{K}_{s}} {q}_{i , k} ( t ) \cdot {z}^{{wp}_{i , k}^{1}} , ( 1 - {q}_{i , k}^{wt} ( t ) ) \cdot {z}^{1} + {q}_{i , k}^{wt} ( t ) \cdot {z}^{0} \} \\ = {Ω}_{ser} \{ {\sum }_{{k}_{s} = 1}^{{K}_{s}} {q}_{i , k} ( t ) \cdot {z}^{{wp}_{i , k}^{1}} , {e}^{- {λ}_{i , k} t} \cdot {z}^{1} + ( 1 - {e}^{- {λ}_{i , k} t} ) \cdot {z}^{0} \} \\ = {\sum }_{{k}_{s} = 1}^{{K}_{s}} {q}_{i , k} ( t ) \cdot ( 1 - {q}_{i , k}^{wt} ( t ) ) \cdot {z}^{{wp}_{i , k}^{1}} + {\sum }_{{k}_{s} = 1}^{{K}_{s}} {q}_{i , k} ( t ) \cdot {q}_{i , k}^{wt} ( t ) \cdot {z}^{0} \\ = {\sum }_{j = 1}^{{n}_{w}} {q}_{i , j}^{w} ( t ) \cdot {z}^{{wp}_{i , j}^{1}}\end{matrix} ,$$

where uᵢ^{w}(z,t) represents the improved general generating function representation method of wind turbine i output model considering wind speed and wind turbine time-varying failure rate, Ωₛₑᵣ represents series operator, q_{i,j}^{w}(t) represents a probability of wind turbine i in state j is represented, and z^{wp}^{_{i,j}}^{^{w}} represents the output value of wind turbine i in state j is wp_{i,j}^{w}.

S4, on the basis of S3, a multi-state output model of a virtual power plant composed of a plurality of distributed wind power is established.

The S4 specifically include:

For N_{w} independent wind turbines in the virtual power plant, the output of N_{w} wind turbines is shown in the following formula:

$$\begin{matrix}{U}^{VPP} ( z , t ) = {Ω}_{par} \{ {u}_{1}^{w} ( z , t ) , … , {u}_{i}^{w} ( z , t ) , … , {u}_{{N}_{w}}^{w} ( z , t ) \} \\ = {\sum }_{i = 1}^{{N}_{w}} {\sum }_{{j = 1}^{}}^{{n}_{w}} {q}_{i , j}^{w} ( t ) \cdot {z}^{{wp}_{j}^{w}} \\ = {\sum }_{m = 1}^{{N}_{vpp}} {q}_{m}^{vpp} ( t ) \cdot {z}^{{VPP}_{m}}\end{matrix} ,$$

where u^{VPP}(z,t) represents an improved general generating function representation method for the output model of virtual power plant by aggregating N_{w} independent wind turbines, Ωₚₐᵣ represents parallel operator, qₘ^{vpp}(t) represents a probability of virtual power plant in state m, and z^{VPP}^{ₘ} represents that the output value of virtual power plant in state m is VPPₘ.

S5, operation risk indicators of the virtual power plant are calculated according to the multi-state output model of the virtual power plant established in S4.

The S5 specifically includes:
according to the multi-state output model of the virtual power plant obtained in S4, the operation risk indicators of the virtual power plant are calculated. The operation risk indicators include the power supply shortage probability D(t) , the expected power supply shortage E(t) and the power supply shortage loss A(t) of industrial users. The specific calculation formula is as follows:

$$D ( t ) = {\sum }_{m} {q}_{m}^{vpp} ( t ) , {VPP}_{m} \geq L ,$$

$$E ( t ) = {\sum }_{w} {q}_{m}^{vpp} ( t ) \cdot {VPP}_{m} ,$$

$$A ( T ) = {\sum }_{t = 0}^{T} ( L - {VPP}_{m} ) {q}_{m}^{vpp} ( t ) cdf ( τ ) , {VPP}_{m} < L ,$$

where D(t) is power supply shortage probability of the virtual power plant, E(t) is expected power supply shortage of the virtual power plant and A(t) is power supply shortage loss for industrial users in the virtual power plant; L represents load value of industrial users powered by the virtual power plant, T represents total power supply time of the virtual power plant, and t represents the time and t ∈[0,T]; τ indicates duration of power outage, cdf(τ) indicates loss function of power supply shortage of industrial users, and is related to the duration τ of power outage.

Embodiments of the present application are as follows.

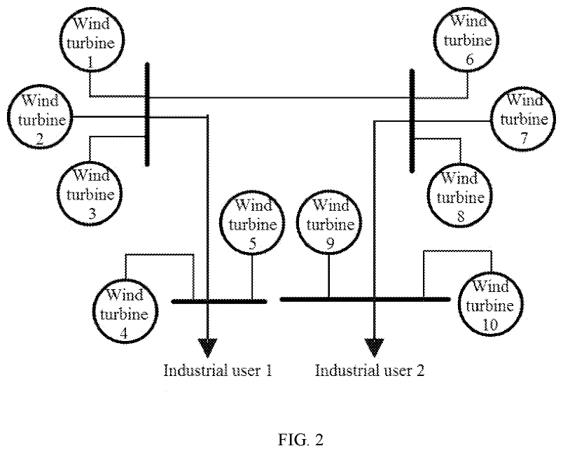

The virtual power plant in the embodiment is composed of 10 distributed wind turbines of 2 Million Watt (MW) and 2 industrial users with electricity demand of 5 MW. The schematic diagram of the virtual power plant structure model shown in FIG. 2 is established. The multi-state model of wind turbine output in Si without considering wind turbine failure is built, and the wind turbine output value and the time-varying probability value at different output values are gotten. Secondly, the wind turbine failure model considering the wind turbine time-varying failure rate in S2 is established, and the failure probability of the wind turbine under the influence of different wind speeds is obtained. Then the multi-state model of single independent wind turbine output considering wind speed and wind turbine time-varying failure rate in S3 is established by using the improved general generating function method and the output model of the virtual power plant composed of 8 distributed wind turbines is established by using the method in S4. Finally, when the virtual power plant runs for 100 hours, the operation risk indicators of the virtual power plant are calculated. The operation risk indicators of the virtual power plant include the power supply shortage probability, the expected power shortage, and the power supply shortage loss of industrial users, in which the loss function of power supply shortage of industrial users is expressed by a piecewise function. The unit losses of industrial users in virtual power plant with different power outage durations are shown in Table 1.

TABLE 1

| Unit loss | Duration of power outage (hours) | | | | |
|---|---|---|---|---|---|
| (RMB/MWh) | 0.01 | 0.5 | 1 | 4 | 8 |
| Industrial | 16.8 | 3.5 | 2.2 | 1.2 | 0.9 |
| user 1 | | | | | |
| Industrial | 96.5 | 22.6 | 15.3 | 13.0 | 10.6 |
| user 2 | | | | | |

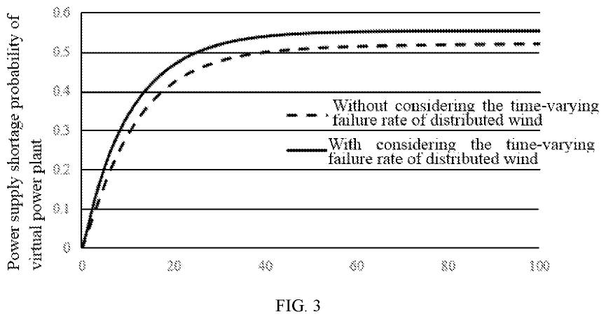

From the above steps, it can be calculated that the power supply shortage probability in a virtual power plant operation risk indicator system whether to consider the time-varying failure rate of distributed wind power is shown in FIG. 3. After 100-hours operation, the expected power supply shortage of virtual power plant without considering the time-varying failure rate of distributed wind and with considering the time-varying failure rate of distributed wind is 422.93 MWh and 435.98 MWh, respectively. The power supply shortage losses of industrial users of virtual power plant without considering the time-varying failure rate of distributed wind power and with considering the time-varying failure rate of distributed wind power are 3700.66 Chinese yuan and 3814.85 Chinese yuan, respectively. Through comparison, it can be found that the power supply shortage probability, expected power shortage and power shortage loss of virtual power plant considering the time-varying failure rate of distributed wind power are all higher than the operation risk indicators of virtual power plant without considering the time-varying failure rate of distributed wind power. When t=100 hours, the power supply shortage probability of virtual power plant considering the time-varying failure rate of distributed wind power is 6.28% higher than that of virtual power plant without considering the time-varying failure rate of distributed wind power. The expected power shortage and power shortage loss of virtual power plant considering the time-varying failure rate of distributed wind power are 3.09% higher than those of virtual power plant without considering the time-varying failure rate of distributed wind power. To sum up, considering the wind turbine time-varying failure rate has certain influence on the operation risk of the virtual power plant, and quantitatively analyzing the influence of the wind turbine time-varying failure rate on the operation risk of the virtual power plant provides reference for the operation of the virtual power plant.

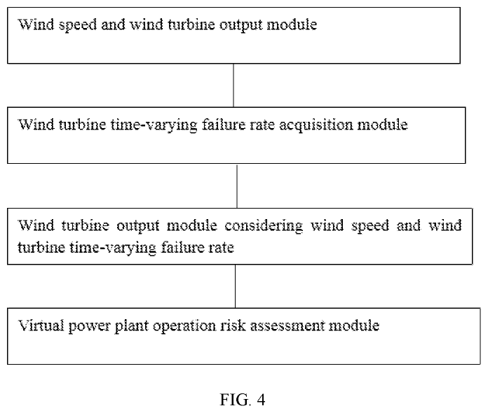

In this embodiment of the application, a virtual power plant operation risk analysis device considering time-varying failure rate of distributed wind power is also constructed, as shown in FIG. 4 and mainly includes a wind speed and wind turbine output module 10, a wind turbine time-varying failure rate acquisition module 20, a wind turbine failure probability acquisition module 30, a wind turbine output module 40 considering wind speed and wind turbine time-varying failure rate, and a virtual power plant operation risk assessment module 50.

The wind speed and wind turbine output module is used to construct the relationship model between wind turbine output and wind speed when the wind turbine is running well, to divide the wind speed into a plurality of states, and establish a multi-state wind speed model, and to calculate the wind turbine output value and the corresponding probability value without considering the wind turbine failure according to the relationship model between wind turbine output and wind speed and the multi-state output model of the wind turbine.

The wind turbine time-varying failure rate acquisition module is used for acquiring the variable failure rate of the wind turbine according to the relationship model between the variable failure rate of the wind turbine caused by wind speed and wind speed, and obtaining the wind turbine time-varying failure rate by adding the basic failure rate of the wind turbine and the variable failure rate of the wind turbine caused by the wind speed.

The wind turbine output module considering wind speed and wind turbine time-varying failure rate is used to build a wind turbine failure model considering wind turbine time-varying failure rate based on the wind turbine time-varying failure rate acquisition module, and to obtain the wind turbine output value and the corresponding probability value considering the wind speed and the wind turbine time-varying failure rate based on the wind turbine output obtained by the wind speed and wind turbine output module.

The virtual power plant operation risk assessment module is used to construct a output model of virtual power plant output model including a plurality of distributed wind power, to establish a virtual power plant operation risk indicator system including power supply shortage probability, expected power supply shortage and power supply shortage loss of industrial users in virtual power plant, and to calculate the power supply shortage probability, expected power supply shortage and power supply shortage loss of industrial users in virtual power plant.

It should be understood by those skilled in the art that the embodiments of the present application can provide methods, systems, or computer program products. Therefore, this application can take the form of an entirely hardware embodiment, an entirely software embodiment, or an embodiment combining software and hardware aspects. Furthermore, the present application may take the form of a computer program product implemented on one or more computer usable storage media (including but not limited to disk storage, Compact Disc Read-Only Memory (CD-ROM), optical storage, etc.). The computer usable storage media contain computer usable program codes.

The application is described with reference to flowcharts and/or block diagrams of methods, devices (systems), and computer program products according to embodiments of the application. It should be understood that each flow and/or block in flowchart and/or block diagram, and combinations of flows and/or blocks in flowchart and/or block diagram can be realized by computer program instructions. These computer program instructions may be provided to the processor of a general-purpose computer, a special-purpose computer, an embedded processor or other programmable data processing equipment to produce a machine, so that the instructions executed by the processor of the computer or other programmable data processing equipment produce a device for implementing the functions specified in one or more flow charts and/or one or more blocks of the block diagram.

These computer program instructions can also be stored in a computer-readable memory that can direct a computer or other programmable data processing equipment to work in a specific way, so that the instructions stored in the computer-readable memory produce an article of manufacture including instruction devices that implement the functions specified in one or more flow charts and/or one or more blocks of the block diagrams.

These computer program instructions may also be loaded on a computer or other programmable data processing equipment, so that a series of operation steps are executed on the computer or other programmable equipment to produce a computer-implemented process, so that the instructions executed on the computer or other programmable equipment provide steps for realizing the functions specified in one or more flows of the flowchart and/or one or more blocks of the block diagram.

The above-mentioned embodiments only describe the preferred mode of the application, but do not limit the scope of the application. On the premise of not departing from the design spirit of the application, all kinds of modifications and improvements made by ordinary technicians in the field to the technical scheme of the application shall fall within the scope of protection determined by the claims of the application.

What is claimed is:

1. A method for analyzing virtual power plant operation risks, comprising:
establishing a multi-state model of wind turbine output;
analyzing influence of a wind speed on a wind turbine time-varying failure rate based on the multi-state model of the wind turbine output, and establishing a wind turbine failure model considering a wind turbine time-varying failure rate;
establishing a multi-state model of the wind turbine output considering the wind speed and the wind turbine time-varying failure rates by a general generating function method based on the multi-state model of the wind turbine output and the wind turbine failure model considering the wind turbine time-varying failure rate;
establishing a multi-state output model of a virtual power plant based on the multi-state model of the wind turbine output considering the wind speed and the wind turbine time-varying failure rate; and
calculating operation risk indicators of the virtual power plant through the multi-state output model of the virtual power plant, and completing analysis of virtual power plant operation risks;
wherein the step of establishing the multi-state model of the wind turbine output comprises:
analyzing a relationship between the wind speed and the wind turbine output without considering wind turbine failure, building the multi-state model of the wind turbine output based on the relationship between the wind speed and the wind turbine output, dividing a wind speed s(t) into Kₛ states, modelling the wind turbine output with Markov process, and dividing wpᵢ¹(t) into Kₛ states, obtaining a time-varying probability value q_{i,k}(t) of the wind turbine output wp_{i,k}¹ of a kₛ-th state, and building the multi-state model of wind turbine output by using the improved general generating function method, wherein wpᵢ¹(t) represents an output of a wind turbine i at the wind speed S(t) at time t.

2. (canceled)

3. The method of claim 1, wherein the relationship between the wind speeds and wind turbine output is:
$$w {p}_{i}^{1} ( t ) = \{ \begin{matrix}0 , 0 \leq s ( t ) \leq {s}_{i}^{ci} or s ( t ) > {s}_{i}^{co} \\ {a}_{i} {s ( t )}^{3} + {b}_{i} , {s}_{i}^{ci} \leq s ( t ) \leq {s}_{i}^{c} \\ {wp}_{i}^{r} , {s}_{i}^{c} \leq s ( t ) \leq {s}_{i}^{co}\end{matrix} ,$$
wherein t represents time, i represents a serial number of a wind turbine, wpᵢ¹(t) represents an output of a wind turbine i at the wind speed S(t) at time t, sᵢ^{ci}, sᵢ^{c}, sᵢ^{co} represent a cut-in wind speed, a rated wind speed and a cut-out wind speed of the wind turbine i, respectively, wpᵢ^{r} represents a rated power of the wind turbine i; aᵢ and bᵢ are correlation coefficients between the output of the wind turbine and the wind speed, respectively,
$${a}_{i} = \frac{{wp}_{i}^{r}}{{( {s}_{i}^{c} )}^{3} - {( {s}_{i}^{c i} )}^{3}} ,$$
$${b}_{i} = \frac{{( {wp}_{i}^{r} {s}_{i}^{ci} )}^{3}}{{( {s}_{i}^{ci} )}^{3} - {( {s}_{i}^{c} )}^{3}} .$$
wherein the time-varying probability value q_{i,k}(t) of the wind turbine output wp_{i,k}¹ of the kₛ-th state is:
$$\{ \begin{matrix}\frac{{dq}_{i , k} ( t )}{dt} = [ {\sum }_{k = 1 , k \neq l}^{{K}_{s}} {q}_{i , l} ( t ) \times {γ}_{k , l}^{s} ] - {q}_{i , k} ( t ) {\sum }_{l = 1 , l \neq k}^{{K}_{s}} {γ}_{k , l}^{s} k = 1 , … , {K}_{s} \\ {q}_{i , k} ( {t}_{0} ) = 1 , {q}_{i , l} ( {t}_{0} ) = 0 , k \neq l\end{matrix} .$$
wherein γ_{k,l}^{s} represents a state transition rate of the wind turbine output from the kₛ-th state to a lₛ-th state, q_{i,k}(t₀) is a time-varying probability value of the wind turbine output in the kₛ-th state of the wind turbine i at time t₀, q_{i,l}(t₀) represents a time-varying probability value of the wind turbine output in the lₛ-th state of the wind turbine i at time t₀, and q_{i,l}(t) represents a time-varying probability value of the wind turbine output in a l state of the wind turbine i at time t;
wherein the multi-state model of the wind turbine output is:
$${u}_{l}^{1} ( z , t ) = {\sum }_{{k}_{s} = 1}^{{K}_{s}} {q}_{i , k} ( t ) \cdot {z}^{{wp}_{i , k}^{1}} ,$$
wherein uᵢ¹(z,t) represents an improved general generating function representation method of output of the wind turbine i regardless of the wind turbine failure, Z represents a state value of a random variable, and z^{wp}^{_{i,k}}^{¹} represents an output value of the wind turbine i is wp_{i,k}¹.

4. The method of claim 1, wherein the wind turbine failure model considering the wind turbine time-varying failure rate comprises:
analyzing the influence of the wind speed on the wind turbine failure rate, and establishing the wind turbine failure model;
λ_{I}(t)=λ_{i,0}+λ_{i,s}(t),
wherein λ_{I} (t) represents the time-varying failure rates of the wind turbine i at time t, λ_{i,0} represents a basic failure rate of the wind turbine i, and λ_{i,s}(t) represents a variable failure rate of the wind turbine i caused by the wind speed at time t;
wherein a relationship model between the variable failure rate of the wind turbine i caused by the wind speed at time t and the wind speed s(t) is as follows:
λ_{i,s}(t)=(λ_{i,max}s(t)²−λ_{i,min}s(t)²)/(sᵢ^{co2}−sᵢ^{ci2})+cₛ,
wherein λ_{i,max} represents the wind turbine failure rate corresponding to the cut-out wind speed sᵢ^{co} of the wind turbine i, λ_{i,min} represents the wind turbine failure rate corresponding to the cut-in wind speed Sᵢ^{ci} of the wind turbine i, and Cₛ represents a constant related to the cut-in wind speed and the cut-out wind speed.

5. The method of claim 4, wherein the basic failure rate of the wind turbine at different wind speed is described by the multi-state model, and the variable failure rate of the wind turbine at different wind speed is considered, and a failure probability of the wind turbine is obtained as follows:
q_{i,k}^{wt}(t)=1−e^{-λ}^{_{i,k}}^{t},
wherein t is time, q_{i,k}^{wt}(t) represents failure probability of the wind turbine iat a kₛ-th wind speed at time t , and λ_{i,k} failure rate of wind turbine i at the kₛ-th wind speed at time t;
based on the failure probability of the wind turbine, the failure model of the wind turbine i in the kₛ-th wind speed state is established by using the improved general generating function method:
uᵢ²(z,t)=(1−q_{i,k}^{wt}(t)·z¹+q_{i,k}^{wt}(t)·z⁰=e^{-λ}^{_{i,k}}^{t}·z¹+(1−e^{-λ}^{_{i,k}}^{t})·z⁰,
wherein uᵢ²(z,t) represents the improved general generating function representation method of the failure model of the wind turbine i considering a influence of wind speed on wind turbine failure probability, z¹ indicates that wind turbine i is in normal operation and z⁰ represents the wind turbine i is in failure.

6. The method of claim 1, wherein the multi-state model of wind turbine output considering the wind speed and the wind turbine time-varying failure rate is:
$$\begin{matrix}{u}_{i}^{w} ( z , t ) = {Ω}_{ser} \{ {u}_{i}^{1} ( z , t ) , {u}_{i}^{2} ( z , t ) \} \\ = {Ω}_{ser} \{ {\sum }_{{k}_{s} = 1}^{{K}_{s}} {q}_{i , k} ( t ) \cdot {z}^{{wp}_{i , k}^{1}} , ( 1 - {q}_{i , k}^{wt} ( t ) ) \cdot {z}^{1} + {q}_{i , k}^{wt} ( t ) \cdot {z}^{0} \} \\ = {Ω}_{ser} \{ {\sum }_{{k}_{s} = 1}^{{K}_{s}} {q}_{i , k} ( t ) \cdot {z}^{{wp}_{i , k}^{1}} , {e}^{- {λ}_{i , k} t} \cdot {z}^{1} + ( 1 - {e}^{- {λ}_{i , k} t} ) \cdot {z}^{0} \} \\ = {\sum }_{{k}_{s} = 1}^{{K}_{s}} {q}_{i , k} ( t ) \cdot ( 1 - {q}_{i , k}^{wt} ( t ) ) \cdot {z}^{{wp}_{i , k}^{1}} + {\sum }_{{k}_{s} = 1}^{{K}_{s}} {q}_{i , k} ( t ) \cdot {q}_{i , k}^{wt} ( t ) \cdot {z}^{0} \\ = {\sum }_{j = 1}^{{n}_{w}} {q}_{i , j}^{w} ( t ) \cdot {z}^{{wp}_{i , j}^{1}}\end{matrix} ,$$
wherein uᵢ^{w}(z,t) represents the general generating function representation method of the output model of the wind turbine i considering the wind speed and the wind turbine time-varying failure rates, Ωₛₑᵣ represents a series operator, q_{i,j}^{w}(t) represents a probability of the wind turbine i in state j, and Z^{wp}^{_{i,j}}^{^{w}} represents an output value of the wind turbine i in state j.

7. The method of claim 1, wherein establishing the multi-state model of the virtual power plant composed of a plurality of distributed wind powers by the multi-state model of wind turbine output considering the wind speeds and the wind turbine time-varying failure rate:
$$\begin{matrix}{U}^{VPP} ( z , t ) = {Ω}_{par} \{ {u}_{1}^{w} ( z , t ) , … , {u}_{i}^{w} ( z , t ) , … , {u}_{{N}_{w}}^{w} ( z , t ) \} \\ = {\sum }_{i = 1}^{{N}_{w}} {\sum }_{{j = 1}^{}}^{{n}_{w}} {q}_{i , j}^{w} ( t ) \cdot {z}^{{wp}_{j}^{w}} \\ = {\sum }_{m = 1}^{{N}_{vpp}} {q}_{m}^{vpp} ( t ) \cdot {z}^{{VPP}_{m}}\end{matrix} ,$$
wherein u^{VPP}(z,t) represents the general generating function representation method for the output model of the virtual power plant by aggregating N_{w} independent wind turbines, and Ωₚₐᵣ represents a parallel operator, qₘ^{vpp}(t) represents a probability of the virtual power plant in state m, and z^{VPP}^{ₘ} in represents that an output value of the virtual power plant in state m is VPPₘ.

8. The method of claim 1, wherein calculating the operation risk indicators of the virtual power plant:
$$D ( t ) = {\sum }_{m} {q}_{m}^{vpp} ( t ) , {VPP}_{m} \geq L ,$$
$$E ( t ) = {\sum }_{w} {q}_{m}^{vpp} ( t ) \cdot {VPP}_{m} ,$$
$$A ( T ) = {\sum }_{t = 0}^{T} ( L - {VPP}_{m} ) {q}_{m}^{vpp} ( t ) cdf ( τ ) , {VPP}_{m} < L ,$$
wherein D(t) is a power supply shortage probability, E(t) is an expected power supply shortage and A(t) is a power supply shortage loss for industrial users, L represents load values of industrial users powered by the virtual power plant, T represents total power supply duration of the virtual power plant, t represents the time and t ∈[0,T], τ represents duration of power outage, and cdf (τ) represents loss function of power supply shortage of the industrial users, and is related to the duration τ of power outage.

9. A device for analyzing virtual power plant operation risks, used to realize the method of claim 1, comprising:
a wind speed and wind turbine output module, used to construct a relationship model between the wind turbine output and the wind speed, divide the wind speed into multiple states, establish a multi-state wind speed model; calculate wind turbine output values and corresponding probability values without considering wind turbine failure according to the relationship model between the wind turbine output and the wind speed and the multi-state output model of the wind turbine;
a wind turbine time-varying failure rate acquisition module, used for acquiring variable failure rate of the wind turbine, and obtaining the wind turbine time-varying failure rate by adding the basic failure rate of the wind turbine and variable failure rate of the wind turbine caused by the wind speed;
a wind turbine output module considering wind speed and wind turbine time-varying failure rate, used for constructing a wind turbine failure model considering wind turbine time-varying failure rate based on the wind turbine time-varying failure rate acquisition module; obtaining the wind turbine output value and a corresponding probability value considering the wind speed and the wind turbine time-varying failure rate based on the wind turbine output obtained by the wind speed and wind turbine output module, and
a virtual power plant operation risk assessment module, used for constructing a virtual power plant output model comprising a plurality of distributed wind powers; establishing a virtual power plant operation risk indicator system comprising a power supply shortage probability, an expected power supply shortage and a power supply shortage loss of industrial users in the virtual power plant, and calculating the power supply shortage probability, the expected power supply shortage and the power supply shortage loss of industrial users in the virtual power plant.
